(19) United States
(12) Patent Application Publication
(10) Pub. No.: US 2025/0364746 A1
(43) Pub. Date: Nov. 27, 2025

(54) CONDUCTOR CONNECTION TERMINAL

(71) Applicant: WAGO Verwaltungsgesellschaft mit beschraenkter Haftung, Minden (DE)

(72) Inventor: Sergej ISAAK, Stedesdorf (DE)

(73) Assignee: WAGO Verwaltungsgesellschaft mit beschraenkter Haftung, Minden (DE)

(21) Appl. No.: 19/219,981

(22) Filed: May 27, 2025

(30) Foreign Application Priority Data
May 27, 2024 (DE) 20 2024 102 746.9

(51) Int. Cl. H01R 13/02; H01R 13/24; H01R 13/629

(52) U.S. Cl. CPC H01R 13/025; H01R 13/24; H01R 13/629

(57) ABSTRACT

A conductor connection terminal with a conductor insertion channel is disclosed, which includes an insulating housing, a busbar, a clamping spring, and an actuating unit. The clamping spring has a contact leg, a spring bend, and a clamping leg. The clamping leg, together with the busbar, forms a clamping point for an electrical conductor insertable into the conductor insertion channel. The clamping leg is movable between an open position and a closed position for the purpose of opening and closing the clamping point. The actuating unit is designed to move the clamping leg into the open position. The clamping point is formed, in particular, by a clamping edge on the clamping leg, which is generally situated on the free end of the clamping leg.

This nonprovisional application claims priority under 35 U.S.C. § 119 (a) to German Patent Application No. 20 2024 102 746.9, which was filed in Germany on May 27, 2024, and which is herein incorporated by reference.

### BACKGROUND OF THE INVENTION

### Field of the Invention

The invention relates to a conductor connection terminal with a conductor insertion channel, which includes an insulating housing, a busbar, a clamping spring, and an actuating unit, the clamping spring having a contact leg, a spring bend, and a clamping leg, the clamping leg, together with the busbar, forming a clamping point for an electrical conductor insertable into the conductor insertion channel, the clamping leg being movable between an open position and a closed position for the purpose of opening and closing the clamping point, the actuating unit being designed to move the clamping leg into the open position.

The clamping point is formed, in particular, by a clamping edge on the clamping leg, which is generally situated on the free end of the clamping leg.

### Description of the Background Art

Conductor connection terminals are known from practice. The actuating unit of the conductor connection terminal is used to return the clamping leg to the open position for the purpose of opening the clamping point, for example to release a clamped conductor. In one variant, this conductor connection terminal may be provided with an automatic connection of the electrical conductor to be clamped when the latter is inserted into the conductor connection terminal. By inserting the electrical conductor, the clamping leg of the clamping spring held in the open position may then be automatically released and effectuate a clamping of the electrical conductor.

With regard to the actuating unit, it is desirable for an effective transfer of force to the clamping leg to be made possible for the purpose of moving it into the open position with little application of force, the actuating unit, however, simultaneously taking up only a small amount of installation space and not impairing the automatic connection mechanism.

### SUMMARY OF THE INVENTION

Against this background, the object of the invention is to provide an improved conductor connection terminal.

In an example, for a conductor connection terminal, it is proposed that the actuating unit has an operating element and an actuating element, the actuating element having a bearing base, an actuating section for actuating the actuating element via the operating element, and a pivot arm for mechanically contacting the clamping leg, the clamping leg having an entrainer section, and the actuating element being designed to pivot around the bearing base during actuation and to move the clamping leg into its open position via the pivot arm engaging with the entrainer section.

In other words, a conductor connection terminal is proposed, which includes a return of the clamping leg into the open position via an actuating unit having an operating element and an, in particular, separate actuating element, the actuating element forming a two-armed lever, pivotable around the bearing base, whose lever arms are formed by the actuating section and the pivot arm. The pivoting movement of the actuating element is transferable to the clamping leg via the pivot arm and the entrainer section, so that the clamping leg may be moved into its open position in the direction of the contact leg. With the aid of the proposed conductor connection terminal, it is possible to achieve a reliably effective return of the clamping leg with little application of force and a compact structural design, due to a lever action which may be implemented with the aid of the actuating element.

A compact, easy-to-handle, and reliably effective actuating mechanism is provided thereby.

The insulating housing of the conductor connection terminal manufactured, for example, from a plastic material receives the busbar and the clamping spring of the conductor connection terminal and protects them from environmental influences and touching. The conductor insertion channel may form a cylindrical or hopper-shaped plug-in channel, at least in sections, which leads to the clamping point of the conductor connection terminal, into which an end section of an electrical conductor may be plugged into the insulating housing in a defined insertion direction and may be removed from the insulating housing against the insertion direction. The busbar, also referred to as a contact piece or power rail, may be a largely rigid electrical conductor, which is formed, for example, by a metal strip, which may be partially bent to form a clamping point according to favorable design possibilities, or it may have a perforated collar produced via a passage.

The clamping spring of the conductor connection terminal may be a predominantly flat component, which may be manufactured, in particular, from an elastically resilient material. The clamping spring has a contact leg for supporting the clamping spring on an adjacent structure, for example on the busbar or the insulating housing, a clamping leg for clamping the conductor to the busbar, as well as a spring bend between the contact leg and the clamping leg for deflecting the clamping spring, so that the contact leg may run opposite the clamping leg, at least in sections. During a movement into its open position, the clamping leg may be movable onto the contact leg. Together with the busbar, the clamping leg may form a clamping point for clamping the electrical conductor to the busbar, in that the conductor is pressed onto the busbar by the clamping leg, in particular by a clamping edge of the clamping leg, using the spring force of the clamping spring, so that a reliable electrical contacting may be established. The clamping leg may be moved between an open position and a closed position for the purpose of opening and closing the clamping point. In the open position of the clamping leg, the latter is situated at a distance from the busbar and a possibly inserted electrical conductor, so that the clamping point is released and the conductor may be inserted into the conductor connection terminal as well as positioned in the region of the clamping point or removed therefrom. In the closed position of the clamping leg, the latter is to be moved onto the busbar and the inserted electrical conductor and applies a contact force to the electrical conductor in the direction of the busbar, so that an electrical contacting is present between the conductor and the busbar.

The conductor connection terminal may be latched in the open position. The conductor connection terminal may be advantageously provided with an automatic conductor connection, in that the conductor connection terminal is designed to automatically move the clamping leg into the closed position when the electrical conductor is inserted into the conductor connection terminal. For this purpose, the conductor connection terminal may have, in particular, a release mechanism, which may be actuated by the inserted conductor and via which the clamping leg may be released from its open position and is able to automatically move into the closed position, due to the spring force. In its open position, the clamping leg may be able to be held in a state of readiness on the busbar or on a contact leg of the clamping spring, for example by a suitable holding structure. It may therefore be provided, in particular, that the actuating unit of the conductor connection terminal is provided primarily to transfer the clamping leg into the open position by guiding or moving or pivoting the clamping leg to the holding structure and less for continuously holding the clamping leg. Further the clamping leg can be held by the actuating unit, in particular by the actuating element.

The actuating unit has an operating element and an actuating element. The operating element and the actuating element may be designed as constituents of the actuating unit structurally separated from each other. The operating element is used to transfer to the actuating element an operating force applied by the user of the conductor connection terminal to the operating unit. The operating element may be actuatable, for example manually, and/or via a tool. The operating element may have a tool receptacle, for example a guide slot for screwdriver. The actuating element may be designed to pivot around the bearing base upon the application of an operating force transferred to the actuating section. If the actuating section is pivoted in the direction of the busbar, the pivot arm of the actuating element may be pivoted in the direction of the actuating section, so that a bobbing movement around the bearing base may be implemented. The actuating section and the pivot arm pivot around the same pivot axis of the bearing base on different movement paths, which result from their different positions in relation to the pivot axis. The pivot arm is constructed in such a way that it may be moved in the direction of the entrainer section of the clamping leg and entrains the latter from a mechanical contacting, i.e., the pivoting movement is continued jointly via the pivot arm and the clamping leg. The clamping leg may be moved hereby into its open position in the direction of the contact leg. The bearing base may include a base leg, which forms a pivot bearing foot of the actuating element, through which the pivot axis of the actuating element runs. The base leg is connected to the actuating section and the pivot arm. For this purpose, the base leg may be limited to the establishment of a direct connection between the actuating section and the pivot arm and to the formation of a pivot bearing foot. However, the base leg may also protrude from the actuating element, at least with one section, at a distance from the pivot arm. The base leg and the pivot arm may protrude in different directions from each other, for example at an angle of 90°±10°. It is conceivable that the pivot arm protrudes approximately perpendicularly from the busbar in the open position, and the base leg extends approximately in parallel to the busbar. The base leg and at least one subsection of the pivot arm may jointly form a C-shaped contour. The bearing base having the base leg, the pivot arm, and the actuating section may be designed to be integral with each other.

The base leg may be supported on the busbar, and the pivot arm may contact the clamping leg on the diametrically opposed side of the busbar for resting the base leg on the busbar. The pivot point of the bearing section and the contact point of the pivot arm are very close to each other, in observation of the vertical line, i.e., the projection points of the vertical line of the contact point and pivot point on the busbar are very close to each other and, when viewed from the side, are nearly one on top of the other, i.e., on a vertical line in relation to the busbar. This alignment between the pivot point and contact point does not have to run exactly perpendicularly to the plane of the busbar (i.e., to the surface of the busbar), but may also have a slight acute angle thereto. Due to this adjacent orientation of the pivot point and contact point, the largest possible displacement path of the clamping leg in the parallel direction to the surface of the busbar is achieved during the pivoting of the pivot element.

It is advantageous if two pivot bearing feet are present at a distance from each other. For this purpose, two base legs may be arranged at a distance from each other. The two base legs may extend in parallel to each other.

The entrainer section of the clamping leg may be a surface region of a front side surface of the clamping leg facing the conductor insertion channel, on which a mechanical contacting and an application of force of the pivot arm associated herewith may take place. The entrainer section may be formed by a partial surface of the, for example rectangular, base surface of the clamping leg or be offset with respect to the base surface, for example protrude from the base surface with a lateral extension contour or brought-out spring tongue.

The actuating element may have two pivot arms extending in parallel to each other and/or two base legs extending in parallel to each other. One pivot arm may extend in each case on both sides of the clamping leg, so that the pivot arms flank the clamping leg on opposite sides. One base leg may extend in each case on both sides of the clamping leg, so that the base legs flank the clamping leg on opposite sides. If the actuating element has two pivot arms, the clamping leg may have two corresponding entrainer sections, so that one pivot arm in each case may mechanically contact an entrainer section of the clamping leg and move the clamping leg thereover. A uniform introduction of force into the clamping leg is made possible hereby, and the latter may be reliably moved without a tendency to tilt as well as with little application of force. Due to two parallel pivot arms and/or two parallel base legs, the actuating element also has an increased stability and is precisely pivotable. The two pivot arms and/or the two base legs may each be provided with the same design in terms of their shape and dimensioning, so that features described for a pivot arm or a base leg may be applied below to both parallel pivot arms and/or to both parallel base legs.

The actuating section may have two actuating arms extending in parallel to each other and a connecting web connecting the actuating arms. A compact and stable actuating element is made available hereby. The connecting web may extend essentially transversely to the actuating arms. The surfaces of the base leg, the pivot arm, and/or the actuating arm, viewed, in particular, on one side of the actuating element in each case, may extend in a common plane, i.e., transitioning into each other without a bend.

The connecting web may have an actuating surface for mechanically contacting via the operating element. The connecting web gains an additional actuation function hereby in addition to the mechanical connection and stabilization function, so that the compact nature of the actuating element is further promoted by functional integration. The actuating surface of the connecting web may face a actuator surface of the operating element. The actuating surface of the connecting web may have a curved surface, at least in sections.

A bent spring tongue may be formed onto the actuating section. The spring tongue may protrude, for example, from the actuating surface of the connecting web described above. The spring tongue may be bent, starting from the actuating surface, in a direction pointing away from the actuator surface of the operating element. The spring tongue may be designed to form a single piece with the actuating section. The spring tongue may form a part of the actuating section and be mechanically contactable by the actuator surface of the operating element. The actuator surface of the operating element may slide along the bent spring tongue during the actuation of the actuating section and thus favor a smooth, gradual actuation of the actuating element, so that a comfortable handling of the operating unit is supported. The spring tongue, which limits a pivoting movement of the operating element, may also prevent a lateral jamming of the operating element on the connecting web.

The pivot arm may be provided with an L-shaped design. This allows the pivot arm to encompass the entrainer section of the clamping leg and facilitate a reliably effective transfer of force to the clamping leg. The L-shaped pivot arm may have a first L leg, with the aid of which the pivot arm is joined to the bearing base and the actuating section. The first L leg may be supported on the busbar in the open position. The L-shaped pivot arm may have a second L leg, which protrudes from the first L leg at an angle, in particular essentially perpendicularly, and is used to mechanically contact the entrainer section. The L-shaped pivot arm is guided laterally past the clamping spring.

The entrainer section may be formed by a projection protruding laterally from the clamping leg. A favorable force application region may be provided hereby via a slight and simple geometric adaptation of the clamping spring for the purpose of moving the clamping spring with the aid of the actuating element. The lateral projection may be seen as a side extension of the front side surface of the clamping leg, which faces the conductor insertion channel, so that the surface of the entrainer section and the front side surface of the clamping leg are situated in one plane. In other words, the entrainer section may form a step in a side surface of the clamping leg, the side surface connecting the front side surface and an opposite back side surface of the clamping leg to each other. The clamping leg may have a greater width in the region of the entrainer section than in a clamping leg region adjacent to the entrainer section. The clamping leg may have, in particular, two laterally protruding projections on opposite sides of the clamping leg, which are mechanically contactable by parallel pivot arms of the actuating element.

The busbar may have a busbar frame with two frame legs extending in parallel to each other, the clamping spring being arranged between the frame legs. For example, the busbar may be a predominantly flat contact element having an inner recess, the recess being limited on at least two sides by frame legs. The recess may be designed, for example, as a passage, so that a perforated collar protrudes from the edges of the recess, on which the clamping spring may be advantageously supported. The frame legs permit a compact and secure receiving of the clamping spring on the busbar and increase the stability of the contact insert of the conductor connection terminal formed by the clamping spring and the busbar. An arrangement of the clamping spring between the frame legs may be understood to be that the clamping spring extends between the frame legs in sections and projects through a recess between the frame legs. For example, an upper section of the clamping spring including the spring bend may extend above the busbar, and a lower section of the clamping spring including a release section to be described below extending below the busbar. A free end of the clamping leg, with the aid of which a clamping point having an inserted electrical conductor may be formed, may be situated approximately at the height of the frame leg or the perforated collar in the closed position, so that the electrical conductor may be reliably clamped against the busbar.

The busbar may have an actuating element receptacle for supporting and guiding the actuating element. A stable arrangement and a defined mobility of the actuating element in the conductor connection terminal is achieved hereby. The actuating element receptacle may be, for example, a notch, a retaining pin, or another suitable receptacle contour for holding the actuating element on the busbar frame, a particularly compact arrangement being able to be provided by a notch. The actuating element receptacle may have, in particular, two actuating element receptacles formed on opposite sides of the busbar. The actuating element receptacle may be configured in such a way that a pivoting movement of the actuating element is not impaired by the actuating element receptacle, for example, it may have a greater width than the actuating element in a receiving section for arrangement in the actuating element receptacle.

The bearing base of the actuating element may extend on a side of the busbar facing away from the spring bend of the clamping spring, and the actuating section and/or the pivot arm of the actuating element may extend on a side of the busbar facing the spring bend of the clamping spring. A stable arrangement and a defined mobility of the actuating element in relation to the busbar is achieved hereby. In other words, the bearing base may be situated below the busbar, and the actuating section and/or the pivot arm may extend above the busbar. A section connecting the bearing base and the pivot arm and/or actuating section thus extends through the actuating element receptacle on the busbar, which, for example, may be designed as a notch in the busbar. For example, the bearing base may mechanically contact an underside of a frame leg of the busbar frame, and the actuating section and/or the pivot arm may mechanically contact an upper side of the frame leg of the busbar frame, depending on the actuation state. It is also conceivable that the busbar has a supporting surface, which abuts, for example, the busbar frame and which may be mechanically contacted by the actuating section during actuation.

The busbar may form a stop for the actuating section and/or for the pivot arm. The mobility of the actuating element is precisely limited hereby. For example, the upper side of a frame leg and/or an adjacent supporting surface, which is mechanically contactable by the actuating section and/or the pivot arm, form(s) a stop surface. Due to the rocker structure of the actuating element, the stop regions may be situated within a plane and be used depending on the deflection state of the actuating element.

The busbar may have a bearing for guiding a pivot region of the bearing base, preferably a bearing for guiding a pivot region of the base leg of the bearing base. A defined pivotability of the actuating element may be achieved hereby. The bearing may be formed, for example, on an underside of a frame leg of the busbar. For example, the pivot region of the bearing base may be provided with a convex design, and the bearing may be provided with a concave design via a suitable radius. This enables the pivot region to roll around the pivot axis running through the pivot region on a bearing surface of the bearing during a pivoting movement of the actuating element.

The clamping leg and the contact leg of the clamping spring may extend between the actuating section and the pivot arm of the actuating element, the pivot arm facing the clamping leg and the actuating section facing the contact leg. The actuating section and the pivot arm may therefore encompass the clamping spring on opposite sides and surround the latter in regions, a stable and reliably effective actuating mechanism for returning the clamping leg to the opened position being able to be achieved. A compact structural design may also be achieved by the arrangement of the operating element on the side of the clamping spring facing away from the conductor insertion channel.

The clamping leg may be designed to be latched on a retaining contour of the contact leg of the clamping spring in the open position. The clamping leg may be temporarily fixed hereby on the contact leg in its open position until an electrical conductor inserted into the conductor connection terminal triggers an automatic movement of the clamping leg into the closed position. The retaining contour may be arranged on a retaining section, the retaining section abutting the contact leg. The retaining contour may be, for example, a retaining edge. The clamping leg may have a retaining tab, with the aid of which the clamping leg may engage behind the retaining edge, so that the clamping leg may be fixed on the contact leg by latching it on the retaining edge. It is conceivable that two retaining edges arranged on opposite side surfaces of the contact leg are provided, which may interact with two correspondingly arranged retaining tabs of the clamping leg. An improved fixing of the clamping leg on the contact leg is made possible hereby.

The contact leg may have a release section for releasing the clamping leg held in the open position when an electrical conductor strikes the release section. A simple and reliably effective release mechanism may be provided hereby, which may be fully integrated into the clamping spring, in particular in interaction with the retaining contour described above, and may thus be implemented in a cost-effective and efficient manner. The release section may have, for example, an activation surface, in the direction of which an electrical conductor inserted into the conductor connection terminal may be guided. The conductor striking the activation surface may result in a movement of the release section and, for example, in a stretching or movement of the retaining section associated therewith, which may effectuate a release of the retaining tab of the clamping leg from the retaining edge of the retaining section, so that the automatic, spring force-induced movement of the clamping leg into the closed position is activated. In other words, a latching of the clamping leg on the contact leg may be released by an application of pressure to the activation surface. The clamping spring may be configured in such a way that a slight movement of the release section by an end of the conductor already results in a triggering of the automatic movement of the clamping leg into the closed position, for example by a comparatively small dimensioning of the retaining contour on the retaining section. The release section of the contact leg, in particular an activation surface of the release section, may be present on a free end of the contact leg. The release section may abut the retaining section of the contact leg directly or via a connecting section.

The insulating housing may have a guide pin protruding into the conductor receiving pocket, which extends into the interior of the conductor receiving pocket from a lateral inner wall of the conductor receiving pocket. The guide pin is arranged between the alignment of the conductor insertion channel or an electrical conductor plugged thereinto and a (vertical) connecting section extending between the release section and the retaining contour and prevents an unintentionally early disengagement by the electrical conductor touching the connecting section before the conductor has been plugged in all the way to the release section. The guide pin guides the plugged-in electrical conductor in the direction of the release section until the electrical conductor strikes the release section.

The release section may have a V-shaped bend. The opening of the V-shaped bend may face an inserted electrical conductor. A centering of electrical conductors having small conductor cross-sections and a constant actuating force for the release mechanism may be achieved hereby. Other variants are also provided, for example a circular indentation within the release section.

The actuating element may be designed as a flat stamped-bent part. A light-weight and compact actuating element may be cost-effectively produced and provided hereby. The actuating element may be designed, for example, as thin-walled sheet metal part.

The operating element may be designed as a pressing element. An easy and comfortable operation of the actuating unit is possible hereby. The pressing element may have a tool receptacle, for example a guide slot for screwdriver. A pressing element may be seen, for example, as an operating element, which may be moved in a translational manner in an actuation channel, in the present case, in particular, being able to move in a translational manner, led by an actuator surface, onto an actuating section of the actuating element, in particular an actuating surface of the actuating section. It is also conceivable, in principle, to design the operating element as a lever, so that the operating element is designed to be pivotable around a pivot axis.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b schematically show a conductor connection terminal with a clamping leg of a clamping spring illustrated in a closed position in a cutaway view and a perspective front view of a spring-force clamping connection, with a faded-out insulating housing;

FIGS. 2a and 2b schematically show the conductor connection terminal with the clamping leg of the clamping spring illustrated in an open position in a cutaway view and a perspective front view of a spring-force clamping connection, with a faded-out insulating housing;

FIGS. 3a and 3b schematically show the conductor connection terminal with the clamping leg of the clamping spring illustrated in the clamped position when an electrical conductor is inserted, in a cutaway view and a perspective front view of a force clamping connection, with a faded-out insulating housing;

FIGS. 4a and 4b schematically show an isolated representation of the clamping spring of the conductor connection terminal in the closed position, in a side view and a perspective view;

FIGS. 5a and 5b schematically show an isolated representation of the clamping spring of the conductor connection terminal in the open position, in a side view and a perspective view;

FIGS. 6a and 6c schematically show an isolated representation of a busbar of the conductor connection terminal in a side view, a perspective view from above, and a perspective view from below; and

FIGS. 7a and 7b schematically show an isolated representation of an actuating element of the conductor connection terminal in a side view and a perspective view.

### DETAILED DESCRIPTION

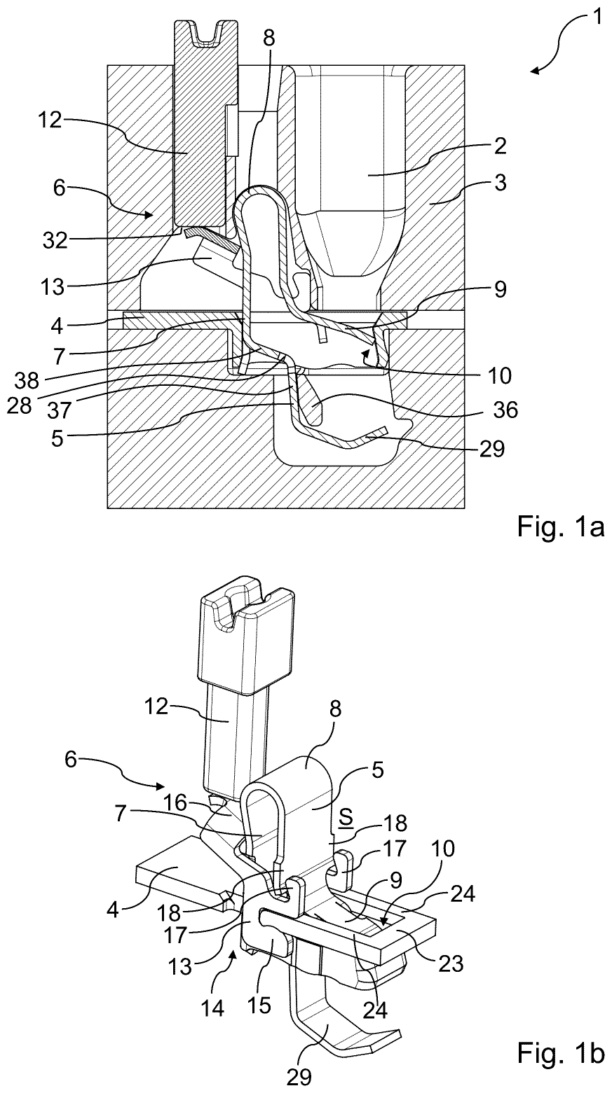

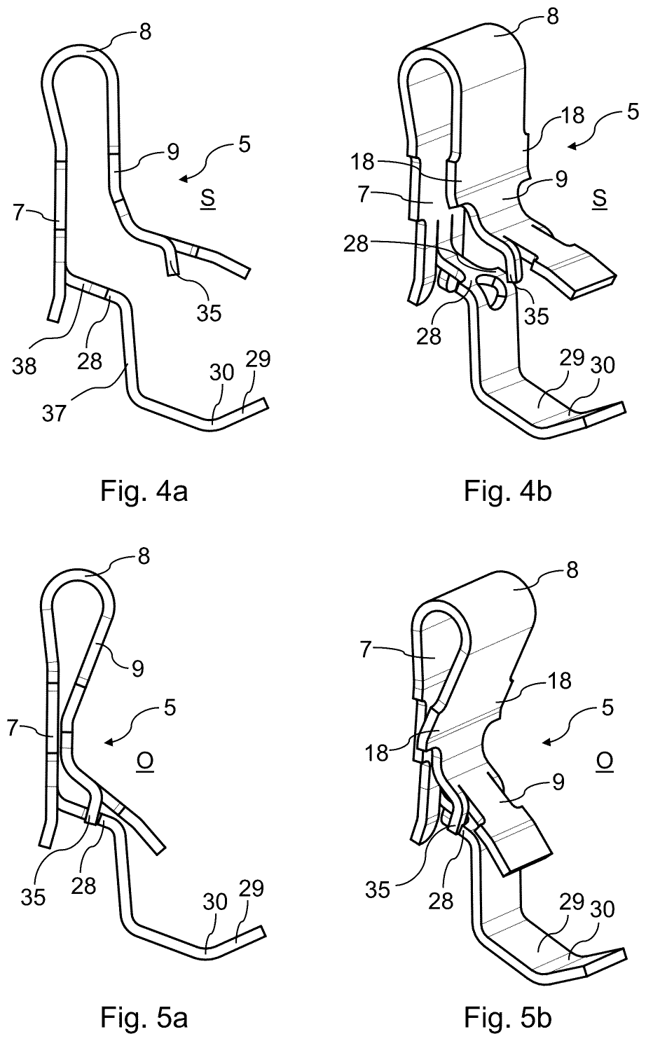

FIGS. 1a through 3b show a conductor connection terminal 1 according to an example in different views and states. FIGS. 4a through 7b show isolated representations of individual components of conductor connection terminal 1 for clarifying structural details of the example.

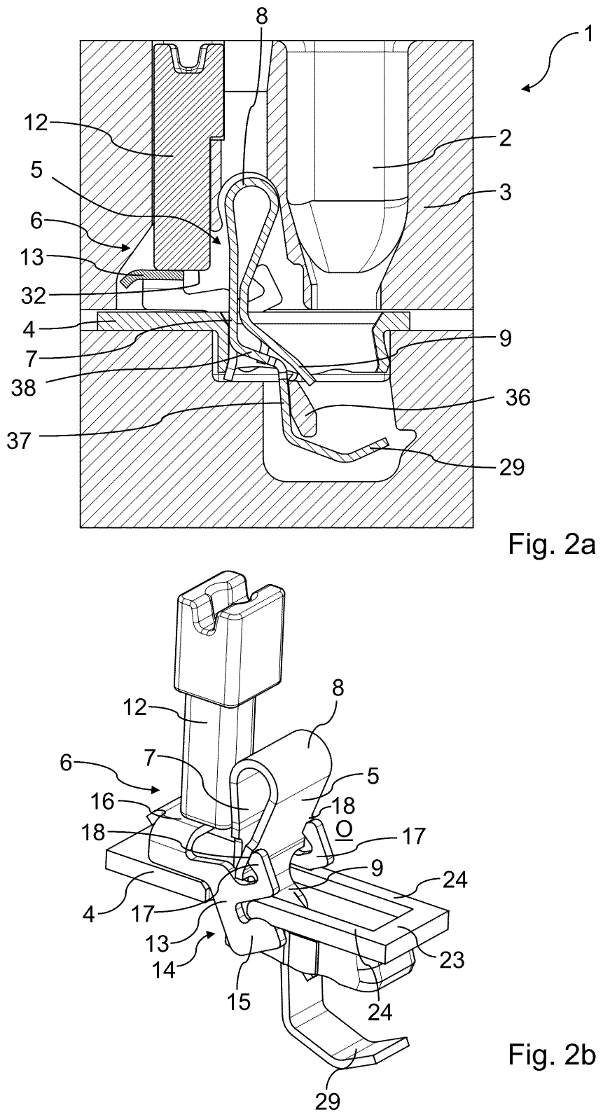

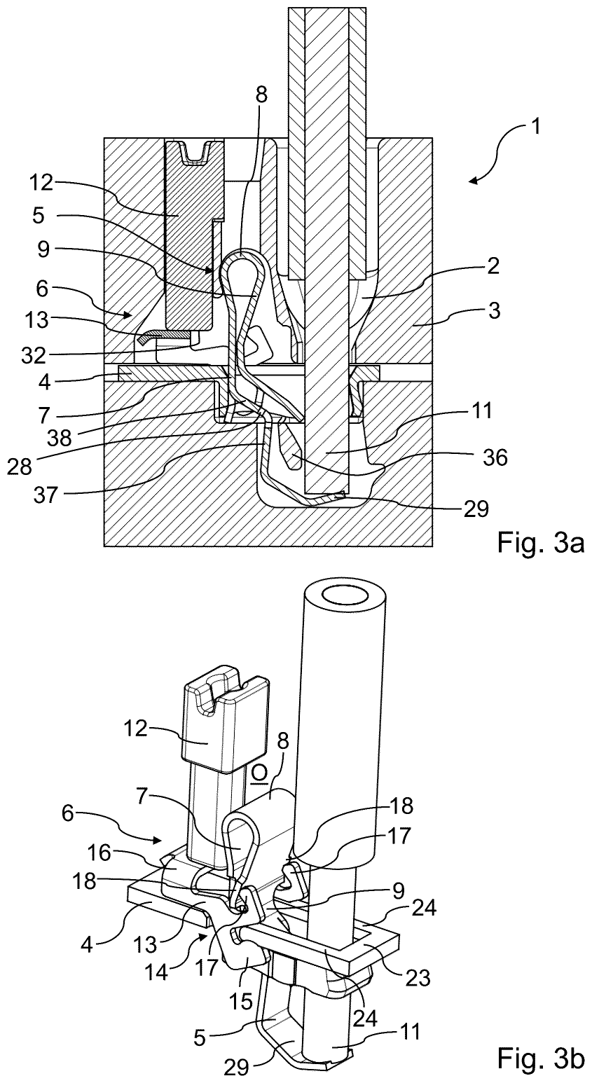

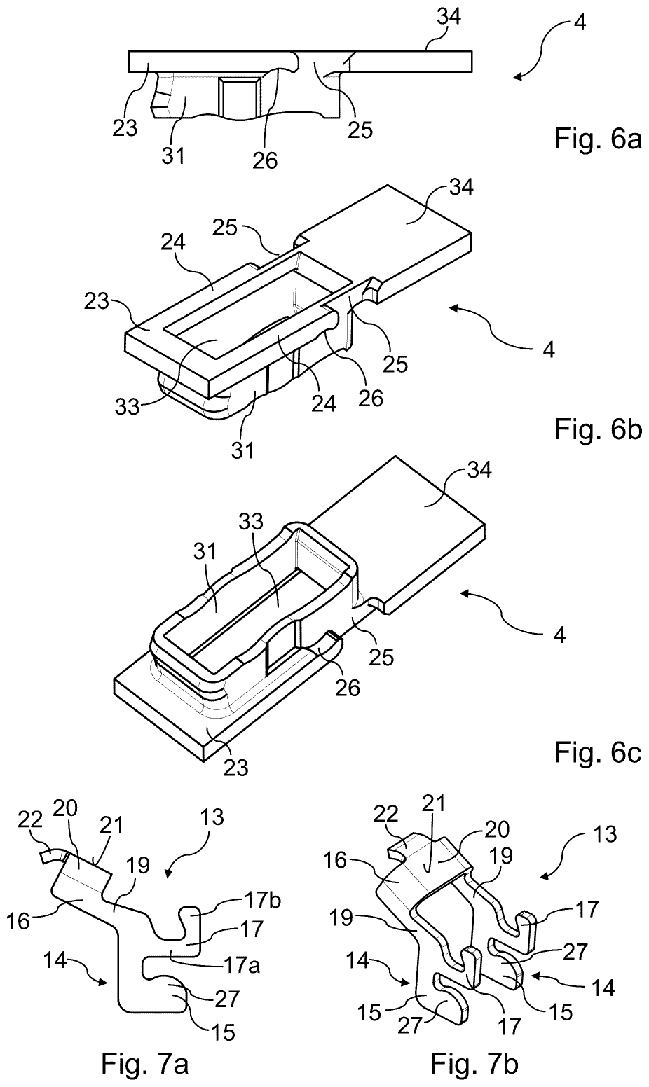

As is apparent in FIGS. 1a, 2a, and 3a, conductor connection terminal 1 has an insulating housing 3 with a conductor insertion channel 2, into which an electrical conductor 11 illustrated in FIGS. 3a and 3b may be inserted. Conductor connection terminal 1 furthermore has a busbar 4, which is shown in FIGS. 1a through 3b and additionally illustrated in an isolated manner in FIGS. 6a through 6c and described in greater detail below. Conductor connection terminal 1 also has a clamping spring 5, which is shown in FIGS. 1a through 3b and additionally illustrated in an isolated manner in FIGS. 4a through 5b. Clamping spring 5 has a contact leg 7, a spring bend 8, and a clamping leg 9. Due to spring bend 8, clamping spring 5 undergoes a deflection in such a way that clamping leg 9 runs opposite contact leg 7, at least in sections. Clamping leg 9, together with a busbar 4, is designed to form a clamping point 10 for an electrical conductor 11 illustrated in FIGS. 3a and 3b, which is insertable into conductor insertion channel 2. Clamping leg 9 is movable between an open position O, illustrated in FIGS. 2a through 3b as well as FIGS. 5a and 5b, and a closed position S, illustrated in FIGS. 1a and 1b as well as FIGS. 4a and 4b, for the purpose of opening and closing clamping point 10. During a movement into its open position O, clamping leg 9 may be moved onto contact leg 7, as illustrated in FIGS. 1a through 3b. In open position O, electrical conductor 11 may be positioned in the region of clamping point 10, as illustrated in FIGS. 3a and 3b. In closed position S, clamping leg 9 is moved in the direction of electrical conductor 11 and applies a contact force to electrical conductor 11 in the direction of busbar 4. Conductor connection terminal 1 is designed to automatically move clamping leg 9 into closed position S when electrical conductor 11 is inserted into conductor connection terminal 1. For this purpose, a retaining section 38 abuts contact leg 7, which has a retaining contour 28 and, following a bend, transitions into a (vertical) connecting section 37, which is abutted by a release section 29 after a further bend. The clamping position of conductor connection terminal 1 is illustrated in FIGS. 3a and 3b. Clamping leg 9 abuts electrical conductor 11, and release section 29 is deflected. This is also clear due to the movement of spring bend 8 and the markedly displaced retaining tab 35, compared to FIG. 2a.

It is further apparent in FIGS. 1a through 3b that conductor connection terminal 1 has an actuating unit 6. Actuating unit 6 is designed to move clamping leg 9 into open position O. It is apparent in FIGS. 1a through 3b that actuating unit 6 has an operating element 12 designed as a pressing element and an actuating element 13, which is separate therefrom. Operating element 12 is used to transfer an operating force to actuating element 13. Actuating element 13 is additionally illustrated in an isolated manner in FIGS. 7a and 7b. Actuating element 13 has a bearing base 14 with a base leg 15. Actuating element 13 furthermore has an actuating section 16 to actuate actuating element 13 via operating element 12. Actuating element 13 also has a pivot arm 17 for mechanically contacting clamping leg 9. Clamping leg 9 has an entrainer section 18. Actuating element 13 is designed to pivot around bearing base 14 during actuation. Actuating element 13 may move clamping leg 9 into its open position O via pivot art 17, which engages with entrainer section 18. As may be understood on the basis of the position of actuating element 13 in FIGS. 1a through 3b, actuating element 13 may act as a two-armed lever and transfer a pivoting movement of actuating element 13 around its bearing base 14 to entrainer sections 18 of clamping leg 9 via pivot arm 17. A reliably effective positioning movement of clamping leg 9 into its open position O is made possible hereby, only a slight operating force onto operating element 12 being necessary, due to the lever effect of actuating element 13. At the same time, conductor connection terminal 1 is provided with a compact design, due to the compact rocking mechanism.

According to example illustrated in FIGS. 1a through 3b as well as FIGS. 7a and 7b, the actuating element has two pivot arms 17, which extend in parallel to each other on both sides of clamping leg 9, and two base legs 15, which extend in parallel to each other. Pivot arms 17 are provided with an L-shaped design according to the illustrated example. As illustrated in FIG. 7a, pivot arms 17 may have a first L leg 17a, with the aid of which pivot arms 17 may be supported on busbar 4, and a second L leg 17b, which is used to mechanically contact entrainer section 18. As is apparent, for example, in FIGS. 4b and 5b, clamping leg 9 has two entrainer sections 18 on opposite sides of clamping leg 9, with which pivot arms 17 may engage, entrainer sections 18 being formed by projections protruding laterally from clamping leg 9, which may each be seen as a lateral step of clamping leg 9, and in whose region clamping leg 9 is made wider than adjacent clamping leg regions. Clamping leg 9 and contact leg 7 of clamping spring 5 extend between actuating element 16 and pivot arms 17 of actuating element 13, pivot arms 17 facing clamping leg 9, and actuating section 16 facing contact leg 7.

Actuating section 16 furthermore has two actuating arms 19, which extend in parallel to each other, as is apparent, for example, in FIG. 7b, and a connecting web 20, which extends transversely to actuating arms 19 and connects actuating arms 19, so that a compact and stable actuating element 13 is formed. As indicated in FIG. 7b, connecting web 20 has an actuating surface 21 for mechanically contacting via the operating element 12. It is moreover apparent, for example in FIGS. 7a and 7b, that a bent spring tongue 22 is formed on actuating section 16. Actuating surface 21 and spring tongue 22 face an actuator surface 32 of operating element 12. Bent spring tongue 22 permits a smooth approach and a gradual pivoting movement of actuating element 13.

According to the example of conductor connection terminal 1 illustrated in FIGS. 1a through 3b, base legs 15 of actuating element 13 extend on a side of busbar 4 facing away from spring bend 8 of clamping spring 5, i.e., below busbar 4, while actuating section 16 and pivot arms 17 of actuating element 13 extend on a side of busbar 4 facing spring bend 8 of clamping spring 5, i.e., above busbar 4.

As is apparent, for example, in FIG. 6b, busbar 4 has a busbar frame 23, which includes frame legs 24 extending in parallel to each other. As illustrated, busbar 4 may be a predominantly flat contact element having an inner recess 33, which is limited by frame legs 24. The recess may be produced by a passage and thereby have a perforated collar 31, on which clamping spring 5 may be supported. FIGS. 1b, 2b, and 3b show that clamping spring 5 is arranged between frame legs 24, i.e., they extend through recess 33. A stable contact insert is formed hereby. As illustrated in FIGS. 6a through 6c, a supporting surface 34 may abut busbar frame 23, on which actuating section 16, in particular actuating arms 19, may be supported during an actuation of actuating element 13. Supporting surface 34 may also form a stop surface for actuating section 16. Frame legs 24 may furthermore form a stop for pivot arms 17. This makes it possible for the rocking movement of actuating element 13 to be limited by busbar 4.

It is also apparent, for example in FIG. 6b, that busbar 4 has an actuating element receptacle 25 designed as a notch on sides opposite each other for supporting and guiding actuating element 13, so that a compact arrangement and a defined mobility of actuating element 13 is achieved. As is apparent in FIGS. 6a through 6c, busbar 4 also has in each case a bearing 26 with a, for example, concavely curved region for guiding a convex pivot region 27 of particular base leg 15 of bearing base 14.

As may be understood on the basis of FIGS. 2a through 3b as well as FIGS. 4a through 5b, clamping leg 9 is designed to latch onto retaining contours 28 of contact leg 7 of clamping spring 5 in open position O. Clamping leg 9 may be temporarily fixed hereby on contact leg 7 in its open position O. As illustrated, retaining contours 28 may be lateral retaining edges, which are able to engage behind retaining tabs 35 of clamping leg 9 illustrated in FIGS. 4a through 5b in a latching manner. For an automatic conductor connection with automatic movement of clamping leg 9 into closed position S, conductor connection terminal 1 has a release mechanism, which is implemented according to the illustrated example by a release section 29 on contact leg 7 facing a free end of contact leg 7. Release section 29 is used to release clamping leg 9 held in open position O when an electrical conductor 11 strikes release section 29. Contact leg 7 is deflected by striking conductor 11 in such a way that retaining tabs 35 of clamping leg 9 are released from retaining contours 28, and the latching is released. Release section 29 has a V-shaped bend 30, via which electrical conductors having small conductor cross-sections may be centered, so that a sufficient release force may be generated.

With the aid of conductor connection terminal 1 described on the basis of the above example, a conductor connection terminal 1 may be provided, which has an automatic conductor connection and a compact and yet reliably effective actuating mechanism for returning clamping leg 9 into its open position O.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a conductor insertion channel;
an insulating housing;
a busbar;
a clamping spring having a contact leg, a spring bend, and a clamping leg, the clamping leg, together with the busbar, forms a clamping point for an electrical conductor that is insertable into the conductor insertion channel, the clamping leg being movable between an open position and a closed position for opening and closing the clamping point; and
an actuating unit adapted to move the clamping leg into the open position, the actuating unit having an operating element and an actuating element, the actuating element having a bearing base, an actuating section for actuating the actuating element via the operating element, and a pivot arm for mechanically contacting the clamping leg, the clamping leg having an entrainer section, and the actuating element being configured to pivot around the bearing base during actuation and to move the clamping leg into the open position via the pivot arm engaging with the entrainer section.

2. The conductor connection terminal according to claim 1, wherein the actuating element has two pivot arms extending substantially in parallel to each other.

3. The conductor connection terminal according to claim 1, wherein the actuating section has two actuating arms extending substantially in parallel to each other and has a connecting web connecting the actuating arms.

4. The conductor connection terminal according to claim 3, wherein the connecting web has an actuating surface for being mechanically contacted by the operating element.

5. The conductor connection terminal according to claim 1, wherein a bent spring tongue is formed on the actuating section.

6. The conductor connection terminal according to claim 1, wherein the pivot arm is provided with an L-shaped design.

7. The conductor connection terminal according to claim 1, wherein the entrainer section is formed by a projection protruding laterally from the clamping leg.

8. The conductor connection terminal according to claim 1, wherein the busbar has a busbar frame with two frame legs extending substantially in parallel to each other, and wherein the clamping spring is arranged between the frame legs.

9. The conductor connection terminal according to claim 1, wherein the busbar has a bearing receptacle to support and guide the actuating element.

10. The conductor connection terminal according to claim 1, wherein the bearing base of the actuating element extends on a side of the busbar facing away from the spring bend of the clamping spring, and wherein the actuating section and/or the pivot arm of the actuating element extends on a side of the busbar facing the spring bend of the clamping spring.

11. The conductor connection terminal according to claim 1, wherein the busbar forms a stop for the actuating section and/or for the pivot arm.

12. The conductor connection terminal according to claim 1, wherein the bearing base has a base leg.

13. The conductor connection terminal according to claim 1, wherein the base leg is supported on the busbar, and the pivot arm contacts the clamping leg on the diametrically opposed side of the busbar for resting the base leg on the busbar.

14. The conductor connection terminal according to claim 12, wherein the bearing base has two base legs arranged at a distance from each other.

15. The conductor connection terminal according to claim 14, wherein the two base legs extend in parallel to each other.

16. The conductor connection terminal according to claim 12, wherein the busbar has a bearing for guiding a pivot region of the base leg of the bearing base.

17. The conductor connection terminal according to claim 1, wherein the clamping leg and the contact leg of the clamping spring extend between the actuating section and the pivot arm of the actuating element, the pivot arm facing the clamping leg, and the actuating section facing the contact leg.

18. The conductor connection terminal according to claim 1, wherein the clamping leg is designed to be latched on a retaining contour of the contact leg of the clamping spring in the open position.

19. The conductor connection terminal according to claim 1, wherein the conductor connection terminal automatically moves the clamping leg into the closed position when the electrical conductor is inserted into the conductor connection terminal.

20. The conductor connection terminal according to claim 19, wherein the contact leg has a release section to release the clamping leg held in the open position when an electrical conductor strikes the release section.

21. The conductor connection terminal according to claim 20, wherein the release section has a V-shaped bend.

22. The conductor connection terminal according to claim 1, wherein the actuating element is a flat stamped-bent part.

23. The conductor connection terminal according to claim 1, wherein the operating element is a pressing element.
